(19) United States
(12) Patent Application Publication
(10) Pub. No.: US 2025/0096283 A1
(43) Pub. Date: Mar. 20, 2025

(54) CONDUCTIVE MEMBER, FUEL CELL, AND ELECTROLYSIS DEVICE

(71) Applicant: Sumitomo Electric Industries, Ltd., Osaka-shi, Osaka (JP)

(72) Inventors: Takahiro HIGASHINO, Osaka-shi (JP); Yohei NODA, Osaka-shi (JP); Koma NUMATA, Osaka-shi (JP); Kosei TAKEDA, Osaka-shi (JP); Naho MIZUHARA, Osaka-shi (JP); Kazuki OKUNO, Osaka-shi (JP); Masatoshi MAJIMA, Osaka-shi (JP)

(73) Assignee: Sumitomo Electric Industries, Ltd., Osaka-shi, Osaka (JP)

(21) Appl. No.: 18/580,813

(22) PCT Filed: Mar. 29, 2022
(86) PCT No.: PCT/JP2022/015470

§ 371 Date: Jan. 19, 2024

(30) Foreign Application Priority Data
Jul. 21, 2021 (JP) 2021-120929

(51) Int. Cl. H01M 8/0245; C25B 1/04; C25B 11/031; C25B 11/055; H01M 8/0232; H01M 8/0258

(52) U.S. Cl. CPC H01M 8/0245; C25B 1/04; C25B 11/031; C25B 11/055; H01M 8/0232; H01M 8/0258

(57) ABSTRACT

This conductive member includes a first layer and a second layer. The first layer is a porous body. The second layer is laminated on the first layer. The first layer is used for a current collector for a fuel cell or an electrode for an electrolysis device. The porosity of the second layer is lower than the porosity of the first layer. The porosity of the second layer is less than or equal to 5%.

### TECHNICAL FIELD

The present disclosure relates to a conductive member, a fuel cell, and an electrolysis device. The present application claims priority based on Japanese Patent Application No. 2021-120929 filed on Jul. 21, 2021. All the contents described in the Japanese patent application are incorporated herein by reference.

### BACKGROUND ART

Conventionally, a device using an electrochemical reaction, such as a fuel cell or an electrolysis device, is known. For example, Japanese Patent Laying-Open No. 2021-68493 discloses a fuel cell including: a current collector that is made of a metal mesh and that is laminated so as to be in contact with an electrode of a cell; and a separator laminated on the current collector, the separator being formed with a flow path of an oxidant or fuel. In addition, Japanese Patent Laying-Open No. 2009-149932 discloses an electrolysis device including an electrode body that is disposed to hold an ion permeable diaphragm from both sides in an electrolytic cell. The electrode body includes a mesh electrode member and a mesh conductor member brazed to the mesh electrode member and having an uneven surface.

### CITATION LIST

### Patent Literature

PTL 1: Japanese Patent Laying-Open No. 2021-68493
PTL 2: Japanese Patent Laying-Open No. 2009-149932

### SUMMARY OF INVENTION

A conductive member according to the present disclosure includes a first layer and a second layer. The first layer has a plurality of holes that is dispersed. The second layer is laminated on the first layer. The first layer and the second layer are used for a current collector for a fuel cell or an electrode for an electrolysis device. The porosity of the second layer is lower than the porosity of the first layer. The porosity of the second layer is less than or equal to 5%.

### BRIEF DESCRIPTION OF DRAWINGS

FIG. 1 is a schematic sectional view of a fuel cell according to a first embodiment.

FIG. 2 is a schematic partial sectional view of a conductive member constituting the fuel cell illustrated in FIG. 1.

FIG. 3 is a partially enlarged schematic view of a first layer of the conductive member illustrated in FIG. 2.

FIG. 4 is an enlarged schematic view of a region IV in FIG. 3.

FIG. 5 is an enlarged schematic view of a region V in FIG. 4.

FIG. 6 is a schematic partial sectional view of a first modification of the conductive member illustrated in FIG. 2.

FIG. 7 is a schematic partial sectional view of a second modification of the conductive member illustrated in FIG. 2.

FIG. 8 is a schematic partial sectional view of a third modification of the conductive member illustrated in FIG. 2.

FIG. 9 is a schematic partial sectional view of a fourth modification of the conductive member illustrated in FIG. 2.

FIG. 10 is a schematic partial sectional view of a fifth modification of the conductive member illustrated in FIG. 2.

FIG. 11 is a flowchart for describing a method for manufacturing the conductive member illustrated in FIG. 2.

FIG. 12 is a schematic view for describing the method for manufacturing the conductive member illustrated in FIG. 2.

FIG. 13 is a schematic view for describing the method for manufacturing the conductive member illustrated in FIG. 2.

FIG. 14 is a schematic view for describing the method for manufacturing the conductive member illustrated in FIG. 2.

FIG. 15 is a schematic view for describing the method for manufacturing the conductive member illustrated in FIG. 2.

FIG. 16 is a schematic view for describing the method for manufacturing the conductive member illustrated in FIG. 2.

FIG. 17 is a schematic sectional view of an electrolysis device according to a second embodiment.

FIG. 18 is a schematic sectional view of a conductive member constituting a modification of the electrolysis device illustrated in FIG. 17.

### DETAILED DESCRIPTION

### Problem to be Solved by the Present Disclosure

In the above-described conventional devices such as a fuel cell and an electrolysis device, the structure around the electrode has a complicated configuration in which a plurality of members is combined. For this reason, these devices have a problem of an increase in manufacturing cost due to an increase in the number of components or a complicated manufacturing process.

The present disclosure has been made to solve the above problems, and an object of the present disclosure is to provide a fuel cell and an electrolysis device that can achieve a reduction in manufacturing cost.

### Advantageous Effect of the Present Disclosure

According to the present disclosure, a fuel cell and an electrolysis device that can achieve a reduction in manufacturing cost can be obtained.

### DESCRIPTION OF EMBODIMENTS

(1) A conductive member according to the present disclosure includes a first layer and a second layer. The first layer is a porous body. The second layer is laminated on the first layer. The first layer is used for a current collector for a fuel cell or an electrode for an electrolysis device. The porosity of the second layer is lower than the porosity of the first layer. The porosity of the second layer is less than or equal to 5%.

With this configuration, the conductive member can be used as an assembly of a current collector connected to an electrode of a cell of a fuel cell and a separator layer including a gas flow path. For example, the first layer is connected to the electrode of the cell. Thus, the second layer can function as a separator layer, and the first layer can function as a gas flow path and a current collector. As a result, the number of components and the number of manufacturing processes of the fuel cell can be reduced as compared with a case where the current collector and the separator layer are individually connected to the cell.

The conductive member can also be used as an electrode for an electrolysis device. For example, the first layer can function as a porous electrode of the electrolysis device, and the second layer can function as a support for supporting the electrode. Accordingly, the number of components and the number of manufacturing processes of the electrolysis device can be reduced as compared with a case where the electrode and the support are individually provided to the electrolysis device. As a result, the manufacturing cost of the fuel cell or the electrolysis device can be reduced.

(2) The conductive member according to (1) may further include a third layer. The third layer may be a porous body that is located on a side of the second layer opposite to the side where the first layer is located and that is laminated on the second layer. The third layer may have a plurality of holes that is dispersed. The porosity of the third layer may be higher than the porosity of the second layer. The second layer may not have a through hole.

In this case, by alternately laminating the conductive member and the cell of the fuel cell, a cell multilayer body of the fuel cell can be easily formed. For example, when the conductive member is laminated between a first cell and a second cell, the first layer functions as a flow path of gas (for example, air) and a current collector for an electrode of the first cell. The third layer functions as a flow path of gas (for example, hydrogen) and a current collector for an electrode of the second cell. The second layer functions as a separator layer (interconnector) that partitions the first cell side and the second cell side. As a result, the manufacturing cost of the fuel cell can be reduced.

(3) In the conductive member according to (2), the porosities of the first layer and the third layer may be greater than or equal to 50%. In this case, the flow rate of the gas can be sufficiently ensured in the first layer and the third layer. Therefore, the performance of the fuel cell can be improved.

(4) In the conductive member according to (2) or (3), the ratio of the total thickness of the first layer and the third layer to the total thickness of the first layer, the second layer, and the third layer may be greater than or equal to 10% and less than or equal to 90%. The thickness of the first layer and the thickness of the third layer may be substantially the same, or the thickness of the first layer and the thickness of the third layer may be different from each other. The configuration of the conductive member can be adjusted according to the device configuration of the fuel cell.

(5) In the conductive member according to (2) to (4), a material constituting the first layer, a material constituting the second layer, and a material constituting the third layer may each contain at least one selected from the group consisting of nickel, cobalt, manganese, iron, copper, chromium, aluminum, zinc, titanium, and tin, and alloys thereof.

In this case, when the conductive member is applied to a fuel cell or an electrolysis device, the performance of the fuel cell or the electrolysis device can be sufficiently ensured. In addition, regarding the conductive member applied to the electrolysis device, a material constituting the conductive member may include at least one selected from the group consisting of nickel, a nickel-aluminum (Ni—Al) alloy, a nickel-zinc (Ni—Zn) alloy, and a nickel-cobalt (Ni—Co) alloy, or a mixture of at least two selected from the group.

(6) In the conductive member according to (2) to (5), at least one of a surface of the first layer on a side opposite to a side where the second layer is located, a surface of the first layer on the side where the second layer is located, a surface of the third layer on a side opposite to a side where the second layer is located, and a surface of the third layer on the side where the second layer is located may have a groove. In this case, the groove formed in the first layer or the third layer can be used as a flow path through which gas such as air or hydrogen flows.

(7) In the conductive member according to (2) to (5), at least one of the first layer and the third layer may have a through hole. In this case, the through hole formed in the first layer or the third layer can be used as a flow path through which gas such as air, hydrogen, or oxygen flows.

(8) In the conductive member according to (1), the second layer may have a plurality of through holes. In this case, when, for example, the conductive member is used as an electrode of an electrolysis device, gas such as oxygen generated by electrolysis of water or the like is easily discharged to the outside of the conductive member serving as the electrode through the through holes of the second layer.

(9) In the conductive member according to (8), the first layer may have a plurality of recesses in the surface facing the through holes of the second layer. In this case, when, for example, the conductive member is used as an electrode of an electrolysis device, the surface area of the portion of the first layer facing the through holes of the second layer can be made larger, due to the recesses, than that in the case where the recesses are not formed. Therefore, it is possible to improve discharge efficiency when oxygen gas or the like generated by electrolysis of water or the like is discharged to the outside of the conductive member through the through holes of the second layer.

(10) In the conductive member according to (8) or (9), a material constituting the first layer and a material constituting the second layer may each contain at least one selected from the group consisting of nickel, cobalt, manganese, iron, copper, chromium, aluminum, zinc, titanium, and tin, and alloys thereof.

In this case, when the conductive member is applied to a fuel cell or an electrolysis device, the performance of the fuel cell or the electrolysis device can be sufficiently ensured. In addition, regarding the conductive member applied to the electrolysis device, a material constituting the conductive member may include at least one selected from the group consisting of nickel, a nickel-aluminum (Ni—Al) alloy, a nickel-zinc (Ni—Zn) alloy, and a nickel-cobalt (Ni—Co) alloy, or a mixture of at least two selected from the group.

(11) In the conductive member according to (1) to (10), the first layer may have a plurality of first holes, a plurality of second holes, and a plurality of third holes. The diameter of the plurality of first holes may be greater than or equal to 1 mm. The diameter of the plurality of second holes may be greater than or equal to 100 μm and less than 1 mm. The diameter of the plurality of third holes may be less than 100 μm. In this case, holes of various sizes as described above are formed, so that the surface area of the first layer can be increased.

(12) A fuel cell according to the present disclosure includes the conductive member according to any of (2) to (7) and (11). In this case, an increase in manufacturing cost of the fuel cell can be suppressed.

(13) An electrolysis device according to the present disclosure includes the conductive member according to any of (8) to (11). In this case, an increase in manufacturing cost of the electrolysis device can be suppressed.

### Detailed Description of Embodiments of the Present Disclosure

### First Embodiment

### <Configurations and Effects of Fuel Cell and Conductive Member>

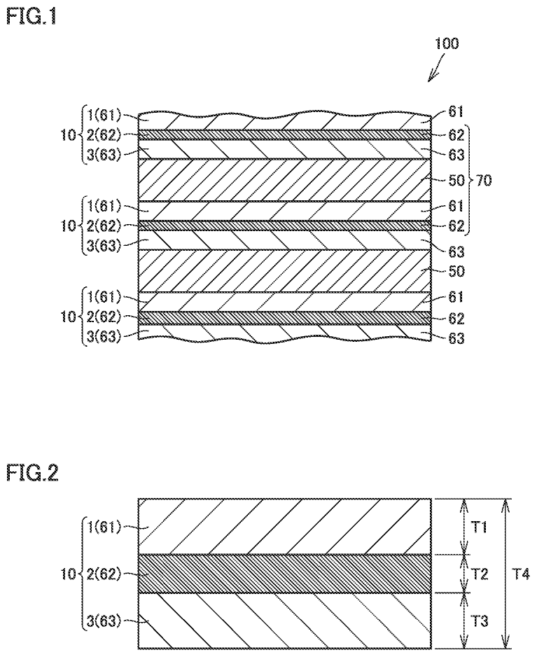

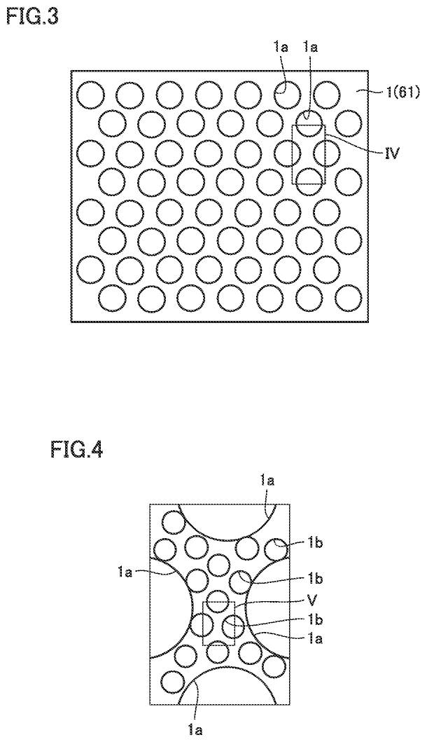

FIG. 1 is a schematic sectional view of a fuel cell 100 according to a first embodiment. FIG. 2 is a schematic partial sectional view of a conductive member 10 constituting fuel cell 100 illustrated in FIG. 1. FIG. 3 is a partially enlarged schematic view of a first layer 1 of conductive member 10 illustrated in FIG. 2. FIG. 4 is an enlarged schematic view of region IV in FIG. 3. FIG. 5 is an enlarged schematic view of region V in FIG. 4. FIGS. 3 to 5 illustrate a cross section of conductive member 10.

As illustrated in FIG. 1, fuel cell 100 has a structure (cell stack structure) in which cell structures 50 and conductive members 10 are alternately laminated. Each cell structure 50 includes two electrodes (an anode and a cathode) and an electrolyte layer (for example, a solid electrolyte layer) disposed between the two electrodes. Conductive member 10 includes a first layer 1 as a porous layer 61, a second layer 2 as a separator layer 62, and a third layer 3 as a porous layer 63. Second layer 2 is laminated on first layer 1. Third layer 3 is located on the side opposite to the side where first layer 1 is located when viewed from second layer 2. Each of first layer 1 and third layer 3 has a plurality of holes that is dispersed. Third layer 3, second layer 2, and first layer 1 are laminated and fixed to each other to constitute conductive member 10. Each of first layer 1, second layer 2, and third layer is made of a conductor.

First layer 1 which is a porous body is connected to, for example, an anode of cell structure 50. First layer 1 serves as a member for supplying fuel such as hydrogen to the anode and a conductor (current collector) having a current collecting function for the anode of cell structure 50.

Second layer 2 laminated under first layer 1 can function as a current collector for one cell structure 50, but here, functions as separator layer 62 that separates gas supplied to adjacent first layer 1 and gas supplied to third layer. The porosity of second layer 2 is lower than the porosities of first layer 1 and third layer 3. Second layer 2 is not formed with a through hole that is a hole extending from a surface of the first layer 1 side to a surface on the third layer 3 side.

Third layer 3 which is a porous body laminated under second layer 2 is connected to a cathode of different cell structure 50 different from cell structure 50 to which first layer 1 is connected. Third layer 3 serves as a member for supplying air to the cathode and a current collector for the cathode of different cell structure 50.

As illustrated in FIG. 1, cell structure 50 and conductive member 10 are alternately laminated to form a cell 70 of the fuel cell including cell structure 50, first layer 1 as porous layer 61 connected to the anode of cell structure 50, second layer 2 as separator layer 62 connected to first layer 1, third layer 3 as porous layer 63 connected to the cathode of cell structure 50, and second layer 2 as separator layer 62 connected to third layer 3.

The porosities of first layer 1 and third layer 3 are greater than or equal to 50%. In this case, the flow rate of gas can be sufficiently ensured in first layer 1 and third layer 3. Therefore, the performance of fuel cell 100 can be improved. The porosities of first layer 1 and third layer 3 may be greater than or equal to 60%, or greater than or equal to 70%. The porosities of first layer 1 and third layer 3 may be greater than or equal to 40%, or greater than or equal to 30%. The porosity of second layer 2 is less than or equal to 5%. The porosity of second layer 2 may be less than or equal to 4%, or less than or equal to 3%. In this case, second layer 2 can function as a separator layer that separates the gas supplied to first layer 1 and the gas supplied to third layer 3.

The porosity of first layer 1, second layer 2, or third layer 3 is defined by the following expression.

$$porosity ( \% ) = [ 1 - \{ M / ( V \times d ) \} ] \times 100$$

M: mass [g] of sample to be measured in first layer 1, second layer 2, or third layer 3
V: volume [cm³] of external shape of sample to be measured
d: density [g/cm³] of material constituting sample to be measured

The “volume of the external shape” described above means the apparent volume of the sample to be measured, and is the total volume of the volume of holes (pores) in the sample to be measured and the volume of the portion other than the holes. Here, the volume of holes does not include a volume, such as a groove or a through hole, formed afterwards by machining such as press working.

As described above, conductive member 10 can be used as an assembly of a current collector connected to the electrode of cell structure 50 of fuel cell 100 and a separator layer including a gas flow path. Specifically, a cell multilayer body of fuel cell 100 can be easily formed by alternately laminating conductive members 10 and cell structures 50 of fuel cell 100. As a result, the number of components and the number of manufacturing processes of fuel cell 100 can be reduced as compared with a case where the current collector and the separator layer are individually connected to cell structure 50. Therefore, the manufacturing cost of fuel cell 100 can be reduced by applying conductive member 10.

In conductive member 10, the ratio of a total thickness (T1+T3) of first layer 1 and third layer 3 to a total thickness T4 of a thickness T1 of first layer 1, a thickness T2 of second layer 2, and a thickness T3 of third layer 3 is greater than or equal to 10% and less than or equal to 90% as illustrated in FIG. 2. The ratio may be greater than or equal to 20% and less than or equal to 80%, or greater than or equal to 30% and less than or equal to 70%. In this case, when conductive member 10 is applied to fuel cell 100, first layer 1 and third layer 3 can sufficiently exhibit a function as a current collector and a function as a member for supplying gas (fuel or air). Thickness T1 of first layer 1 and thickness T3 of third layer 3 may be substantially the same, or thickness T1 of first layer 1 and thickness T3 of third layer 3 may be different from each other. Accordingly, the configuration of conductive member 10 can be adjusted according to the device configuration of fuel cell 100.

As illustrated in FIGS. 3 to 5, in conductive member 10 (see FIG. 1), the plurality of holes formed in first layer 1 includes a plurality of first holes 1a, a plurality of second holes 1b, and a plurality of third holes 1c. The diameter of the plurality of first holes 1a as coarse holes is, for example, greater than or equal to 1 mm. The diameter of the plurality of second holes 1b as medium-diameter holes is, for example, greater than or equal to 100 μm and less than 1 mm.

As illustrated in FIG. 4, second holes 1b are formed in a portion of first layer 1 located between first holes 1a. The diameter of the plurality of third holes 1c as small-diameter holes is, for example, less than 100 μm. As illustrated in FIG. 5, third holes 1c are formed in a portion of first layer 1 located between second holes 1b. First layer 1 may also contain an oxide 1d as illustrated in FIG. 5. The size of oxide 1d (for example, the maximum width or area of oxide 1d in FIG. 5) may be substantially equal to the size of third hole 1c (for example, the maximum width or area of third hole 1c in FIG. 5). Oxide 1d may be, for example, zirconia.

The plurality of holes formed in third layer 3 may also include first holes 1a, second holes 1b, and third holes 1c as in first layer 1. Similar to first layer 1, third layer 3 may contain oxide 1d. In this case, holes of various sizes (first holes 1a, second holes 1b, third holes 1c) as described above are formed, so that the surface area of first layer 1 or third layer 3 can be increased. Due to the formation of first holes 1a, second holes 1b, and third holes 1c that differ in size as described above, first layer 1 and third layer 3 can have different functions which are a function of supplying gas (fuel or air) to cell structure 50 and a function as a current collector.

Note that the diameter of each of first hole 1a, second hole 1b, and third hole 1c can be measured with “PORE! SCAN” by Heisen Yoko Co., Ltd., or measured by a combination of microscope observation and a mercury intrusion technique.

A material constituting first layer 1, a material constituting second layer 2, and a material constituting third layer 3 each contain at least one selected from the group consisting of nickel (Ni), cobalt (Co), manganese (Mn), iron (Fe), copper (Cu), chromium (Cr), aluminum (Al), zinc (Zn), titanium (Ti), and tin (Sn), and alloys thereof. More specifically, the material constituting first layer 1 may contain an element in which the crystal structure of the oxide is a spinel structure. For example, first layer 1 may contain at least one element selected from the group consisting of nickel, cobalt, manganese, iron, and copper. The materials constituting second layer 2 and third layer 3 may be an alloy having high heat resistance, such as an iron-chromium (Fe—Cr) alloy represented by stainless steel. In this case, when conductive member 10 is applied to fuel cell 100, the performance of fuel cell 100 can be sufficiently ensured. In another configuration, the materials constituting first layer 1, second layer 2, and third layer 3 may be an alloy having high corrosion resistance, such as a Ni—Cr alloy, for example.

### Modification

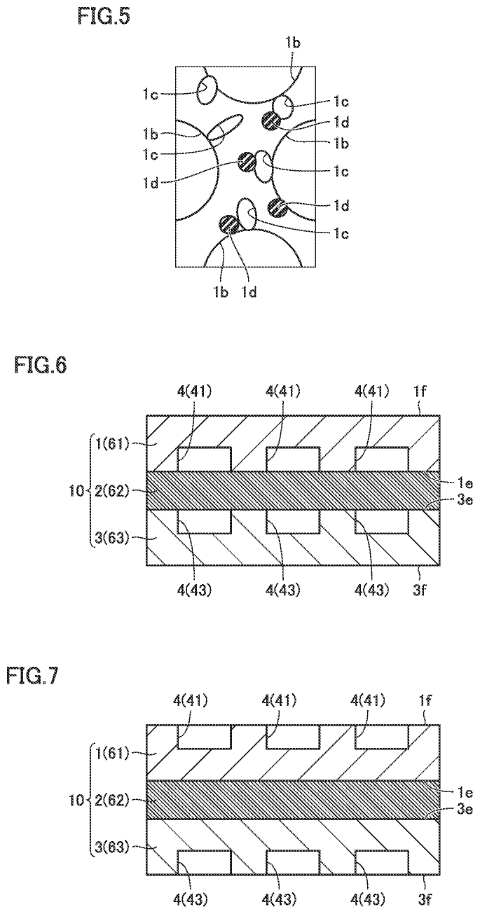

FIG. 6 is a schematic partial sectional view of a first modification of conductive member 10 illustrated in FIG. 2. Conductive member 10 illustrated in FIG. 6 basically has the same configuration as conductive member 10 illustrated in FIG. 2, but is different from conductive member 10 illustrated in FIG. 2 in that grooves 4 are formed in first layer 1 and third layer 3. In conductive member 10 illustrated in FIG. 6, groove 4 which is, for example, a flow path 41 of fuel such as hydrogen is formed in a surface 1e of first layer 1 on a side where second layer 2 is located. In addition, groove 4 which is an air flow path 43 is formed in a surface 3e of third layer 3 on the side where second layer 2 is located.

FIG. 7 is a schematic partial sectional view of a second modification of conductive member 10 illustrated in FIG. 2. Conductive member 10 illustrated in FIG. 7 basically has the same configuration as conductive member 10 illustrated in FIG. 6, but is different from conductive member 10 illustrated in FIG. 6 in arrangement of grooves 4 formed in first layer 1 and third layer 3. In conductive member 10 illustrated in FIG. 7, groove 4 which is, for example, flow path 41 of fuel such as hydrogen is formed in a surface 1f of first layer 1 on a side opposite to the side where second layer 2 is located. In addition, groove 4 which is air flow path 43 is formed in a surface 3f of third layer 3 on a side opposite to the side where second layer 2 is located.

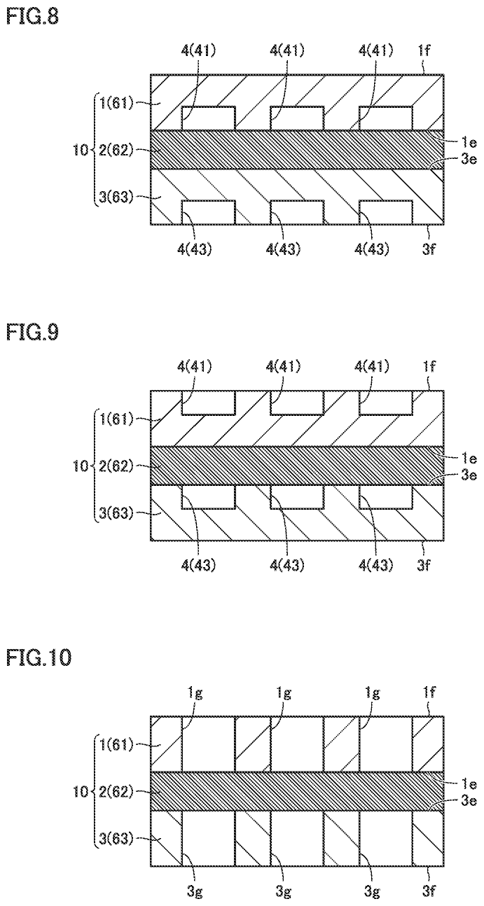

FIG. 8 is a schematic partial sectional view of a third modification of conductive member 10 illustrated in FIG. 2. Conductive member 10 illustrated in FIG. 8 basically has the same configuration as conductive member 10 illustrated in FIG. 6, but is different from conductive member 10 illustrated in FIG. 6 in arrangement of grooves 4 formed in third layer 3. In conductive member 10 illustrated in FIG. 8, groove 4 which is air flow path 43 is formed in surface 3f of third layer 3 on the side opposite to the side where second layer 2 is located. In first layer 1, groove 4 which is flow path 41 of fuel such as hydrogen is formed in surface 1e on the side where second layer 2 is located, as in conductive member 10 illustrated in FIG. 6.

FIG. 9 is a schematic partial sectional view of a fourth modification of conductive member 10 illustrated in FIG. 2. Conductive member 10 illustrated in FIG. 9 basically has the same configuration as conductive member 10 illustrated in FIG. 6, but is different from conductive member 10 illustrated in FIG. 6 in arrangement of grooves 4 formed in first layer 1. In conductive member 10 illustrated in FIG. 9, groove 4 which is flow path 41 of fuel is formed in surface 1f of first layer 1 on the side opposite to the side where second layer 2 is located. In third layer 3, groove 4 which is air flow path 43 is formed in surface 3e on the side where second layer is located, as in conductive member 10 illustrated in FIG. 6.

In conductive members 10 illustrated in FIGS. 6 to 9, the depth of each groove 4 may be less than the thickness of first layer 1 or third layer 3, and may be less than or equal to 50% of the thickness of first layer 1 or third layer 3. As a planar shape of groove 4 in plan view seen from a direction perpendicular to surface 1e of first layer 1, any shape can be adopted, for example, a linear shape, a lattice shape, a meandering flow path shape in which a linear portion and a bent portion are alternately arranged, an arc shape, a shape obtained by combining a plurality of concentric circles and a straight line connecting the concentric circles, and the like. In FIGS. 6 to 9, groove 4 formed in first layer 1 and groove 4 formed in third layer 3 are arranged so as to overlap each other in plan view. However, groove 4 formed in first layer 1 and groove 4 formed in third layer 3 may be arranged so as not to overlap each other at least partially in plan view.

FIG. 10 is a schematic partial sectional view of a fifth modification of conductive member illustrated in FIG. 2. Conductive member 10 illustrated in FIG. 10 basically has the same configuration as conductive member 10 illustrated in FIG. 2, but is different from conductive member 10 illustrated in FIG. 2 in that through holes 1g and 3g are formed in first layer 1 and third layer 3. In conductive member 10 illustrated in FIG. 10, through holes 1g are formed in first layer 1, through holes 1g extending from surface 1e of first layer 1 on the second layer 2 side to surface 1f on the side opposite to the side where second layer 2 is located. In addition, through holes 3g are formed in third layer 3, through holes 3g extending from surface 3e of third layer 3 on the second layer 2 side to surface 3f on the side opposite to the side where second layer 2 is located.

Through holes 1g and 3g can have any planar shape such as a circular shape, a quadrangular shape, a polygonal shape, or an elliptical shape. A groove (not illustrated) connecting the plurality of through holes 1g may be formed in surface 1e or surface 1f of first layer 1. A groove (not illustrated) connecting the plurality of through holes 3g may be formed in surface 3e or surface 3f of third layer 3. In FIG. 10, through hole 1g formed in first layer 1 and through hole 3g formed in third layer 3 are arranged so as to overlap each other in plan view. However, through hole 1g formed in first layer 1 and through hole 3g formed in third layer 3 may be arranged so as not to overlap each other at least partially in plan view.

In conductive members 10 illustrated in FIGS. 6 to 10, grooves 4 or through holes 1g or 3g formed in first layer 1 or third layer 3 can be used as a flow path through which gas such as air or hydrogen flows. Therefore, the performance of fuel cell 100 to which conductive member 10 is applied can be improved.

### <Method for Manufacturing Conductive Member>

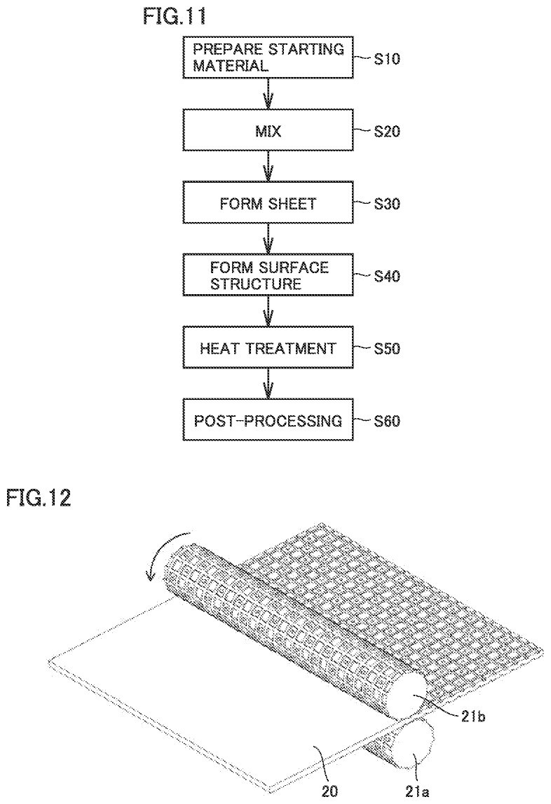

FIG. 11 is a flowchart for describing a method for manufacturing the conductive member illustrated in FIG. 2. FIGS. 12 to 16 are schematic views for describing the method for manufacturing conductive member 10 illustrated in FIG. 2.

As illustrated in FIG. 11, first, a starting material preparation step (S10) is performed in the method for manufacturing conductive member 10. In this step (S10), starting material powder that is a starting material of conductive member 10 and a binder are prepared. As the starting material powder, powder of metal constituting conductive member 10, a pore-forming material for forming a plurality of holes, and the like are prepared.

Next, a mixing step (S20) is performed. In this step (S20), the starting material powder and the binder prepared in step (S10) are mixed to form a starting material paste.

Next, a sheet forming step (S30) is performed. In this step (S30), the above-mentioned starting material paste is molded into a sheet shape to obtain a sheet member as an intermediate body.

Next, a surface structure forming step (S40) is performed. In this step (S40), a surface structure such as grooves, recesses, and holes is formed on the surface of the sheet member in accordance with the application and required performance of conductive member 10. In this step (S40), a sheet member 20 is processed using, for example, processing rolls 21a and 21b as illustrated in FIG. 12. As illustrated in FIG. 12, processing rolls 21a and 21b are arranged to face each other with sheet member 20 interposed therebetween. A surface structure to be transferred to the surface of sheet member 20 is formed on surfaces of rolls 21a and 21b. By such processing, a structure such as holes, recesses, and grooves is formed in sheet member 20. Further, by using roll processing using rolls 21a and 21b as illustrated in FIG. 12, the surface structure can be continuously formed on sheet member 20. Furthermore, the sheet member can be densified by rolling sheet member 20 with rolls 21a and 21b.

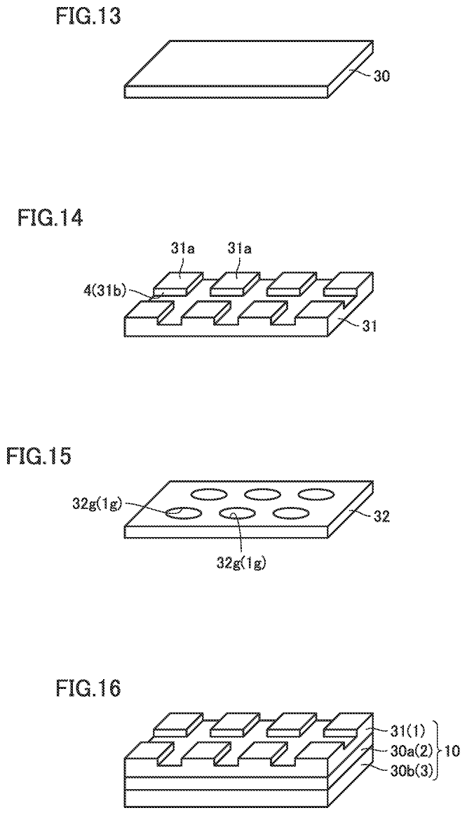

Next, a heat treatment step (S50) is performed. In this step (S50), sheet member 20 on which the surface structure is formed is heated, whereby the binder is removed from sheet member 20, and the starting material powder is reduced and sintered. When a pore-forming material is used, the pore-forming material is volatilized or thermally decomposed to form minute holes in the sheet member. As a result, a conductive sheet is obtained that has the surface structure formed in step (S40) and that is to constitute conductive member 10. Examples of the conductive sheet thus obtained include conductive sheets 30, 31, and 32 having various shapes as illustrated in FIGS. 13 to 15. For example, conductive sheet 30 having a flat surface as illustrated in FIG. 13 is conceivable. Alternatively, conductive sheet 31 having a groove structure 31b to be groove 4 may be obtained by forming a plurality of protrusions 31a on the surface as illustrated in FIG. 14. Alternatively, through holes may be formed in sheet member 20 in step (S40), whereby conductive sheet 32 formed with through holes 32g to be through holes 1g (see FIG. 10) as illustrated in FIG. 15 may be obtained.

Next, a post-processing step (S60) is performed. In this step (S60), the plurality of conductive sheets 30, 31, and 32 obtained in step (S50) are combined to obtain conductive member 10 as illustrated in FIG. 2. For example, conductive member 10 as illustrated in FIG. 2 is formed by laminating and fixing a plurality of conductive sheets. Alternatively, conductive member 10 illustrated in FIG. 16 may be obtained by, for example, laminating and fixing conductive sheet 31 on which groove structure 31b illustrated in FIG. 14 is formed, conductive sheet 30a having a flat surface and a relatively small porosity as illustrated in FIG. 13, and a conductive sheet 30b having a flat surface and a relatively large porosity. As a method for connecting the conductive sheets, any conventionally known method including bonding with a bonding material such as a solder can be used. The thickness, size, surface shape, and the like of conductive sheets 30, 31, and 32 to be combined can be appropriately selected according to characteristics and the like required for conductive member 10. In this way, conductive member 10 as illustrated in FIG. 2 can be obtained.

Note that the formation of the conductive sheet and the formation of conductive member 10 (joining of the plurality of conductive sheets) may be simultaneously performed by laminating a plurality of sheet members having the surface structure formed thereon and then performing the heat treatment step (S50).

### Second Embodiment

### <Configurations and Effects of Electrolysis Device and Conductive Member>

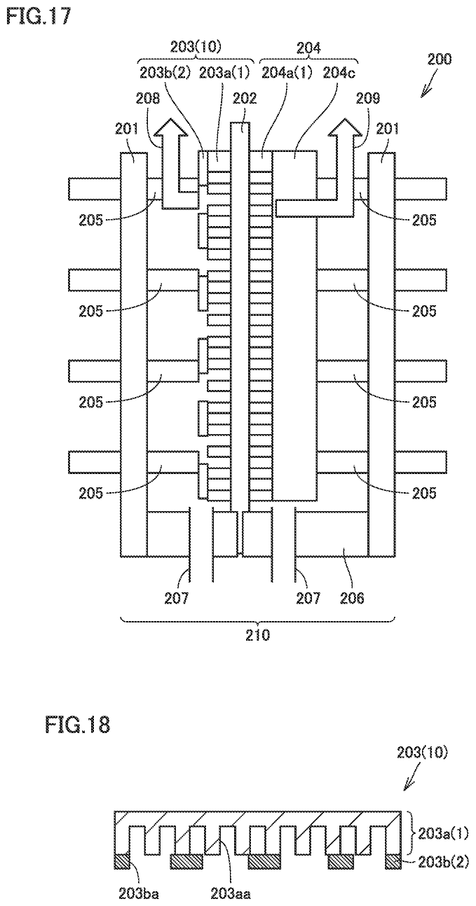

FIG. 17 is a schematic sectional view of an electrolysis device 200 according to a second embodiment. FIG. 17 illustrates an electrolysis cell 210 of electrolysis device 200. Electrolysis device 200 may include a plurality of electrolysis cells 210. Electrolysis cell 210 of electrolysis device 200 mainly includes two bipolar plates 201, a diaphragm 202, an oxygen electrode 203, a hydrogen electrode 204, and a columnar support 205. Oxygen electrode 203 and hydrogen electrode 204 are disposed with diaphragm 202 therebetween. Two bipolar plates 201 are disposed with oxygen electrode 203 and hydrogen electrode 204 therebetween.

Oxygen electrode 203 and hydrogen electrode 204 are supported by columnar support 205. A pipe 207 is installed at a bottom portion 206 located below oxygen electrode 203 and hydrogen electrode 204. Pipe 207 supplies a solution (for example, alkaline water such as a KOH aqueous solution) as an electrolyte to electrolysis device 200. When power is supplied to oxygen electrode 203 and hydrogen electrode 204, the solution is electrolyzed. As a result, oxygen is generated from the oxygen electrode 203 side as indicated by an arrow 208, and hydrogen is generated from the hydrogen electrode 204 side as indicated by an arrow 209. In electrolysis device 200 illustrated in FIG. 17, conductive member 10 is used as oxygen electrode 203.

Oxygen electrode 203 as conductive member 10 is a multilayer body including a porous layer 203a and a support layer 203b which are laminated. Porous layer 203a as first layer 1 has a plurality of holes that is dispersed. Porous layer 203a is formed with through holes that extend from the surface on the diaphragm 202 side to the surface on the support layer 203b side. The configuration of porous layer 203a is similar to the configuration of first layer 1 of conductive member 10 in the first embodiment illustrated in FIGS. 3 to 5. That is, similar to first layer 1 illustrated in FIGS. 3 to 5, porous layer 203a also has a plurality of first holes 1a (see FIG. 3), a plurality of second holes 1b (see FIG. 4), and a plurality of third holes 1c (see FIG. 5).

Support layer 203b as second layer 2 is laminated and fixed on porous layer 203a as first layer 1. The porosity of support layer 203b as second layer 2 is lower than the porosity of porous layer 203a as first layer 1. Support layer 203b is formed with a plurality of through holes that extend from one surface to the other surface of support layer 203b. The through holes formed in support layer 203b serve as a discharge path of oxygen gas generated in oxygen electrode 203. In support layer 203b, the porosity of a portion where the through holes are not formed is, for example, less than or equal to 5%.

As described above, conductive member 10 can be used as oxygen electrode 203 for electrolysis device 200. That is, first layer 1 can be used as porous layer 203a that is a porous electrode of electrolysis device 200, and second layer 2 can be used as support layer 203b that supports porous layer 203a. As a result, the number of components and the number of manufacturing processes of electrolysis device 200 can be reduced as compared with a case where a porous electrode as oxygen electrode 203 and a support are individually provided to electrolysis device 200. Accordingly, the manufacturing cost of electrolysis device 200 can be reduced.

Hydrogen electrode 204 mainly includes a porous layer 204a and a cushion layer 204c. Porous layer 204a is disposed so as to face diaphragm 202. Cushion layer 204c is connected to a back surface of porous layer 204a opposite to the surface facing diaphragm 202. Porous layer 204a is made of a conductor. Porous layer 204a is formed with through holes that extend from the surface on the diaphragm 202 side to the surface on the cushion layer 204c side. As porous layer 204a, a metal porous body such as Celmet (registered trademark) or a mesh metal, for example, can be used. Conductive member 10 can also be used as hydrogen electrode 204 for electrolysis device 200. In this case, due to the presence of the support layer, it is possible to effectively receive a pressing force from columnar support 205 and cushion layer 204c located on the opposite side with respect to diaphragm 202 as viewed from hydrogen electrode 204.

As a material of cushion layer 204c, any material can be used as long as the material has elasticity. For example, a woven cloth mattress, a coil mattress, a member including a leaf spring structure, or the like can be used as cushion layer 204c. Cushion layer 204c can have any configuration as long as a pressing force can be applied from columnar support 205 located on the opposite side with respect to diaphragm 202 as viewed from hydrogen electrode 204 toward hydrogen electrode 204.

A material constituting porous layer 203a as first layer 1 and a material constituting support layer 203b as second layer 2 each contain at least one selected from the group consisting of nickel, cobalt, manganese, iron, copper, chromium, aluminum, zinc, titanium, and tin, and alloys thereof. More specifically, regarding oxygen electrode 203 as conductive member 10 applied to electrolysis device 200, a material constituting oxygen electrode 203 may include at least one selected from the group consisting of nickel, a nickel-aluminum (Ni—Al) alloy, a nickel-zinc (Ni—Zn) alloy, and a nickel-cobalt (Ni—Co) alloy, or a mixture of at least two selected from the group. In this case, when conductive member 10 is applied to electrolysis device 200, the performance of electrolysis device 200 can be sufficiently ensured.

### Modification

FIG. 18 is a schematic sectional view of conductive member 10 constituting a modification of electrolysis device 200 illustrated in FIG. 17. FIG. 18 corresponds to a schematic sectional view of conductive member 10 in the horizontal direction in electrolysis device 200 in FIG. 17. The electrolysis device including conductive member 10 illustrated in FIG. 18 basically has the same configuration as electrolysis device 200 illustrated in FIG. 17, but is different from electrolysis device 200 illustrated in FIG. 17 in the configuration of oxygen electrode 203 as conductive member 10. Conductive member 10 of the electrolysis device illustrated in FIG. 18 is oxygen electrode 203, and includes porous layer 203a as first layer 1 and support layer 203b as second layer 2. Support layer 203b is formed with a plurality of through holes 203ba. Porous layer 203a as first layer 1 has a plurality of recesses 203aa formed in a surface exposed from through holes 203ba of support layer 203b as second layer 2. In this case, due to the formation of recesses 203aa, the surface area of the portion of porous layer 203a as first layer 1 facing through holes 203ba of support layer 203b can be made larger than that in a case where recesses 203aa are not formed. Therefore, in addition to the same effect as that of electrolysis device 200 illustrated in FIG. 17, oxygen gas generated by electrolysis of water or the like can be efficiently discharged to the outside of oxygen electrode 203 through the through holes 203ba of support layer 203b.

The embodiments and modifications disclosed herein are to be considered in all respects as illustrative and not restrictive. The scope of the present invention is defined not by the above embodiments but by the claims, and is intended to include meanings equivalent to the claims and all modifications within the scope.

### REFERENCE SIGNS LIST

1: first layer, 1a: first hole, 1b: second hole, 1c: third hole, 1d: oxide, 1e, 1f, 3e, 3f: surface, 1g, 3g, 32g, 203ba: through hole, 2: second layer, 3: third layer, 4: groove, 10: conductive member, 20: sheet member, 21a, 21b: roll, 30, 30a, 30b, 31, 32: conductive sheet, 31a: protrusion, 31b: groove structure, 41, 43: flow path, 50: cell structure, 61, 63, 203a, 204a: porous layer, 62: separator layer, 70: cell, 100: fuel cell, 200: electrolysis device, 201: bipolar plate, 202: diaphragm, 203: oxygen electrode, 203aa: recess, 203b: support layer, 204: hydrogen electrode, 204c: cushion layer, 205: columnar support, 206: bottom portion, 207: pipe, 208, 209: arrow, 210: electrolysis cell

1. A conductive member comprising:
a first layer that is a porous body; and
a second layer laminated on the first layer, wherein
the first layer is used for a current collector for a fuel cell or an electrode for an electrolysis device,
the second layer has a porosity lower than a porosity of the first layer, and
the porosity of the second layer is less than or equal to 5%.

2. The conductive member according to claim 1, further comprising a third layer that is a porous body, the third layer being located on a side of the second layer opposite to a side where the first layer is located and being laminated on the second layer, wherein
the third layer has a porosity higher than the porosity of the second layer, and
the second layer has no through hole.

3. The conductive member according to claim 2, wherein the porosity of each of the first layer and the third layer is greater than or equal to 50%.

4. The conductive member according to claim 2, wherein a ratio of a total thickness of the first layer and the third layer to a total thickness of the first layer, the second layer, and the third layer is greater than or equal to 10% and less than or equal to 90%.

5. The conductive member according to claim 2, wherein a material constituting the first layer, a material constituting the second layer, and a material constituting the third layer each contain at least one selected from the group consisting of nickel, cobalt, manganese, iron, copper, chromium, aluminum, zinc, titanium, and tin, and alloys thereof.

6. The conductive member according to claim 2, wherein at least one of a surface of the first layer on a side opposite to a side where the second layer is located, a surface of the first layer on the side where the second layer is located, a surface of the third layer on a side opposite to a side where the second layer is located, and a surface of the third layer on the side where the second layer is located has a groove.

7. The conductive member according to claim 2, wherein at least one of the first layer or the third layer has a through hole.

8. The conductive member according to claim 1, wherein the second layer has a plurality of through holes.

9. The conductive member according to claim 8, wherein the first layer has a plurality of recesses in a surface facing the through holes of the second layer.

10. The conductive member according to claim 8, wherein a material constituting the first layer and a material constituting the second layer each contain at least one selected from the group consisting of nickel, cobalt, manganese, iron, copper, chromium, aluminum, zinc, titanium, and tin, and alloys thereof.

11. The conductive member according to claim 1, wherein
the first layer has:
a plurality of first holes having a diameter greater than or equal to 1 mm;
a plurality of second holes having a diameter greater than or equal to 100 μm and less than 1 mm; and
a plurality of third holes having a diameter less than 100 μm.

12. A fuel cell comprising the conductive member according to claim 2.

13. An electrolysis device comprising the conductive member according to claim 8.
